(19) United States
(12) Patent Application Publication
(10) Pub. No.: US 2021/0060602 A1
(43) Pub. Date: Mar. 4, 2021

(54) UNIVERSAL PAINT APPLICATOR WITH PIVOT-ARM LOCKING MECHANISM

(71) Applicant: TRUE PROGRESSION LLC, Portland, OR (US)

(72) Inventors: Tomas Farias, Portland, OR (US); Kevin Troudt, Portland, OR (US)

(21) Appl. No.: 17/098,350

(22) Filed: Nov. 14, 2020

Related U.S. Application Data
(63) Continuation of application No. PCT/US2019/031981, filed on May 13, 2019.
(60) Provisional application No. 62/671,401, filed on May 14, 2018.

(51) Int. Cl. B05C 17/02

(52) U.S. Cl. CPC B05C 17/0217; B05C 17/0212; B05C 17/0205

(57) ABSTRACT

A paint applicator configured for use in combination with a hollow-core paint roller cover includes a handle and a pair of pivot arms extending therefrom. Each pivot arm includes a proximate end rotatably mounted to the handle and an opposite, distal end to which is pivotably mounted a hub assembly. A pivot arm actuator is cooperatively linked to the pivot arms such that movement of the actuator in opposed first and second directions causes the pivot arms to rotate toward and away from one another. Each hub assembly includes a rotatable hub frictionally engage the inside surface of the roller cover such that, when the pivot arms are rotated toward one another, the hubs enter and retain the roller cover therebetween. An actuator lock carried by the handle assembly includes a lock slide displaceable between locked and unlocked positions that, respectively, prevent and permit movement of the pivot arm actuator.

### CROSS-REFERENCE TO RELATED APPLICATION/PRIORITY CLAIMS

The present application is a continuation of International Application Serial No. PCT/US2019/031981 filed May 13, 2019 pursuant to the Patent Cooperation Treaty, and under the title “UNIVERSAL PAINT APPLICATOR WITH PIVOT-ARM LOCKING MECHANISM.” Application PCT/US2019/031981 claimed priority benefits in U.S. Provisional Application No. 62/671,401 filed May 14, 2018 under the title “UNIVERSAL PAINT APPLICATOR WITH PIVOT-ARM LOCKING MECHANISM.”

The present application claims the benefit of the filing date of Provisional Application Ser. No. 62/671,401, as well as the filing date of PCT Application No. PCT/US2019/031981, based on the priority chain set forth above. Moreover, the entireties of the disclosures, including the drawings, of both previous applications in the aforesaid priority chain are incorporated herein by reference as if set forth fully in the present application.

### BACKGROUND

Although not so limited is utility or scope, embodiments of the present invention relate generally to paint applicators and, more particularly, to paint roller systems or roller-type applicators that employ a roller cover including a cylindrical tubular roller core with an inside surface and an outside surface with a nap or pile of absorbent material configured to alternatively absorb and distribute paint.

Decorative painting of surfaces such as walls and ceilings with a roller-type applicator can be challenging and messy. Even professional painters are continually confronted with time-intensive preparation techniques, difficult-to-reach locations, lengthy take-down and cleanup routines, and awkward painting tools. Novice painters face even more daunting challenges when undertaking a home improvement painting project because they are not familiar with best painting practices or tools. Generally, paint is difficult to remove from carpets, drapery, clothing, and the like. If done improperly, a painting project can quickly spiral into something undesirable.

Conventional roller-type paint applicators cause “fat edge” to accumulate along the edges of the roller because of an imbalance of pressure caused by the general hook-shape of a paint roller applicator in which the roller cover is support for rotation from only one side. Additionally, it is difficult and unpleasant to change a wet paint roller cover with a replacement roller cover because the painter frequently comes in contact with wet paint and spreads it to clothes, floors, or other nearby items.

To address the aforementioned problems, there was devised a UNIVERSAL PAINT APPLICATOR that is now the subject of U.S. Pat. No. 9,308,548, granted Apr. 12, 2016 (hereinafter, the “548 patent”). More specifically, paint applicators embodied within the scope of the '548 patent can (i) accommodate roller covers of disparate lengths, (ii) facilitate rapid, tidy, and hands-free changing of roller covers, and (iii) facilitate the application of more balanced forces to each end of a roller cover during application in order to avoid “fat edge,” which is a term employed by some painters to indicate the undesired, uneven accumulation of paint on one side of the roller resulting in uneven application. As successful as that paint applicators within the scope of the '548 patent have proven in practice, they are also characterized by certain limitations under certain conditions. The limitations of certain “real-world” implementations of apparatus covered by the '548 patent inspired innovation of the additional elements disclosed and claimed herein.

Based on the preceding background, it is to be understood that the present patent application is drawn principally to improvements to the apparatus that are the subject of U.S. Pat. No. 9,308,548. Accordingly, because much of the structure constituting the improvements can only be appreciated in the context of the subject apparatus of the '548 patent, much of the structure shown and described in that patent is reiterated in the present case.

### SUMMARY

In an illustrative embodiment, a universal paint applicator is configured for use in combination with a roller cover including a cylindrical roller-cover core with an inside surface and an outside surface carrying an absorbent material for alternatively absorbing and depositing paint on a surface. The applicator includes a handle assembly (alternatively referred to as a “handle”) that extends longitudinally along a handle axis. Carried by, and extending forwardly of, the handle are first and second pivot arm assemblies which, as further explained below, are configured for the cooperative retention and release of a roller cover.

Each pivot arm assembly includes a pivot arm having a proximate end by which it depends from the handle assembly for rotation about a pivot arm axis and a distal end located opposite the proximate end and disposed forwardly of the handle assembly. A bi-directional pivot arm actuator is carried by the handle and cooperatively linked to each pivot arm assembly such that movement of the pivot arm actuator in a first direction causes the pivot arms to rotate toward one another and movement of the actuator in a second direction, opposite the first direction, causes the pivot arm assemblies to rotate away from one another. In a typical version, the pivot arm assemblies, while extending forwardly of the handle, are disposed with general symmetry about the handle axis which, it is to be understood, is an imaginary line of infinite length extending through the lengthwise extent of the handle.

Coupled to the distal end of each of the first and second pivot arms is a hub assembly. Each hub assembly is pivotably coupled to its respective pivot arm for angular movement, relative to that pivot arm, about a hub-pivot axis. In various versions, the degree of angular hub movement is limited by design to be within a predetermined angular range so as to facilitate proper hub alignment for “capturing” a roller cover between the hubs, an aspect that will be more fully appreciated upon further examination of the specification. Additionally, the hubs of some versions include hub caps that are tapered or conical in order to guide and align each hub into the roller-cover core as the inwardly-facing hubs are drawn toward one another.

Each hub assembly includes a hub axle and a hub mounted for rotation on the hub axle about a hub-rotation axis defined by the hub axle. The hub includes an outer surface configured to frictionally engage the inside surface of the roller-cover core such that the hubs of the first and second pivot arms cooperate to engage and retain the roller cover between the pivot arms. Moreover, the hub-rotation axes, hub-pivot axes, and pivot arm axes are movable into disparate mutual orientations such that, when the pivot arms are mutually spread to various degrees, the hub-rotation axes can be aligned to define a common roller-cover rotation axis so that the roller cover cooperatively retained by the hubs can be of any length between a predetermined minimum length and a pre-determined maximum length.

In one alternative configuration, bi-directional pivot arm actuation is facilitated in part by the inclusion at the proximate end of each pivot arm of a pivot arm gear having pivot-gear teeth. The pivot arm actuator comprises a worm-drive shaft carrying a worm gear with teeth that intermesh with the pivot-gear teeth of each pivot arm. Thusly assembled, that rotation of the worm-drive shaft in a first direction causes the pivot arms to rotate about their pivot arm axes inwardly toward one another, while rotation of the worm-drive shaft in a second direction opposite the first direction causes the pivot arms to mutually spread apart in an outward direction. The inward (i.e., toward “clamping”) and outward (i.e., spreading) motion of the pivot arms facilitate, respectively, engagement and disengagement of the outer surfaces of the hubs with the inside surface of the roller-cover core.

Each of various alternative embodiments includes an actuator lock carried by the handle assembly. The actuator lock includes a lock slide linearly displaceable along the handle axis between a locked position and unlocked position. The locked position is such that the lock slide mechanically interferes with the pivot arm actuator in order to prevent movement of the actuator and pivot arms, and the unlocked position is such that the lock slide does not mechanically interfere with movement of the pivot arm actuator and pivot arms.

In various embodiments, some of the same mechanisms that facilitate bi-directional pivot-arm actuation also facilitate actuator locking. According to one version, the worm-drive shaft further carries external drive-shaft teeth. The pivot arm actuator further includes a ring gear disposed coaxially with the worm-drive shaft and having an interior surface that carries internal ring-gear teeth and an exterior surface annularly disposed about a portion of the handle assembly and accessible to a user. At least one planet gear is disposed between the interior surface of the ring gear and the worm-drive shaft. The at least one planet gear has external planet-gear teeth that intermesh with the internal ring-gear teeth and the external drive-shaft teeth such that rotation of the ring gear by a user causes rotation of the planet gear and, in turn, rotation of the worm-drive shaft, thereby causing the pivot arm assemblies to pivot one of (a) toward and (b) away from one another, depending on rotation direction of the ring gear about the handle axis.

In one thusly configured version, the locked and unlocked positions of the lock slide are such that, respectively, (i) the lock slide mechanically interferes with the ring gear to prevent rotation of the ring gear and (ii) the lock slide does not mechanically interfere with the ring gear so that the ring gear is free to rotate. More specifically, the lock slide carries a gear-engagement portion that is caused to be inserted between two adjacent ring-gear teeth when the lock slide is in the locked position.

Representative embodiments are more completely described and depicted in the following detailed description and the accompanying drawings.

### BRIEF DESCRIPTION OF THE DRAWINGS

FIG. 1 is a cross-sectional/“transparent” view of an illustrative universal paint applicator;

FIG. 2 is an exploded view of the universal paint applicator of FIG. 1;

FIG. 3 is an exterior assembled view of the universal paint applicator of FIGS. 1 and 2;

FIG. 4 depicts an illustrative universal paint applicator retaining for rotation between a pair of pivot arms a cylindrical roller cover of predetermined length;

FIG. 5 shows the paint applicator of FIG. 4 retaining a roller cover of lesser length than the roller cover of FIG. 4, and the pivot arms drawn commensurately closer together;

FIG. 6 is a cross-sectional detail of an illustrative hub assembly;

FIG. 7 depicts a universal paint applicator having pivot arms for selectively retaining for rotation a roller cover therebetween, the pivot arms being moveable toward and away from one another by a pivot arm actuator that can be selectively locked by an actuator lock in order to prevent unwanted movement of the pivot arms;

FIG. 8 is a closeup view—relative to the view of FIG. 7—showing portions of the pivot arm actuator and the actuator lock;

FIG. 9 depicts the paint applicator of FIGS. 7 and 8 in a partially disassembled state that reveals some of the internal components for actuating the pivot arms and the actuator lock; and

FIG. 10 shows the paint applicator of FIGS. 7-9 is a state of the further disassembly relative to the state of disassembly depicted in FIG. 9.

### DETAILED DESCRIPTION

The following description of variously embodied universal paint applicators with pivot-arm locking members is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

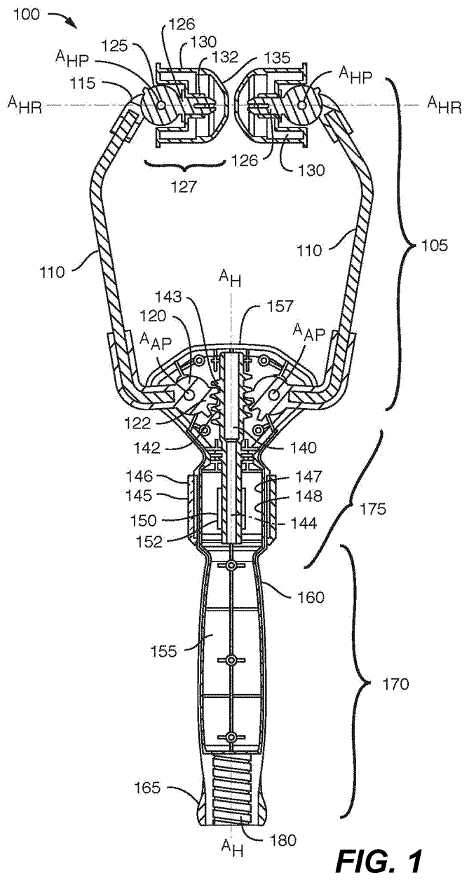

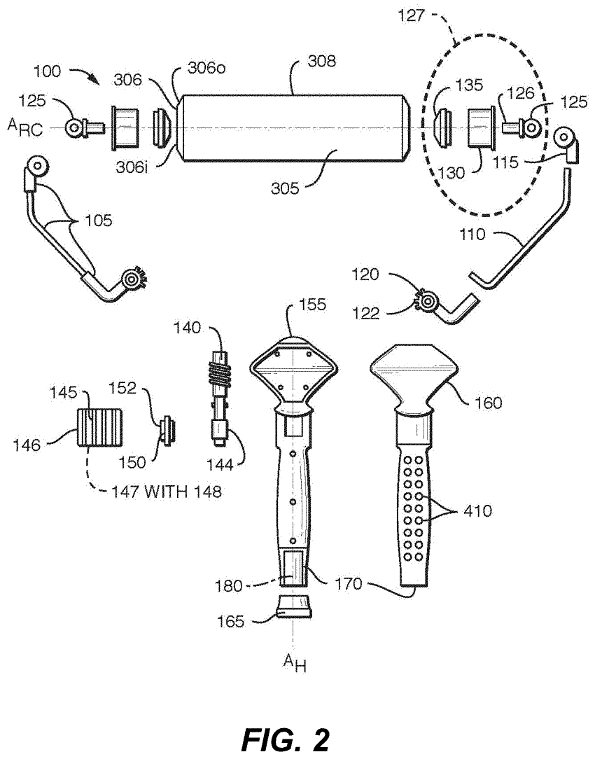

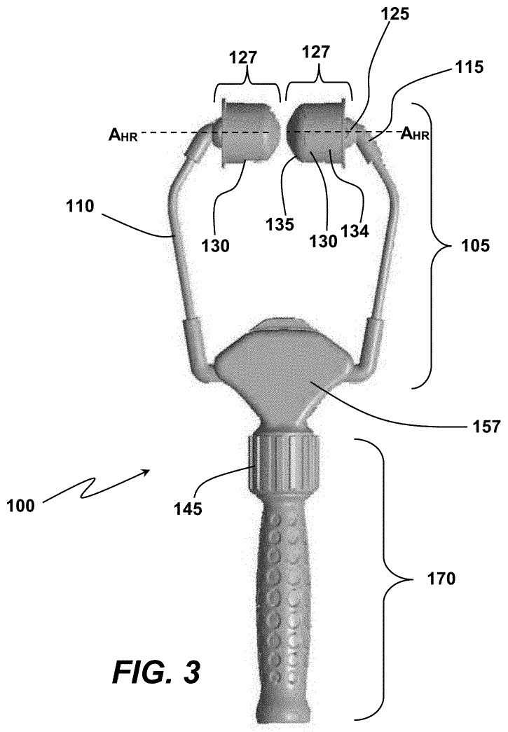

With initial reference to the cross-sectional/“transparent” view of FIG. 1, the exploded view of FIG. 2 and the exterior assembled view of FIG. 3, an illustrative embodiment of a universal paint applicator 100 features a dual pivot arm configuration that, among other advantages, provides shock-absorption and force balancing that facilitate even paint application. More specifically, the paint applicator 100 includes a pair of pivot arm assemblies 105 comprising first and second pivot arm assemblies 105 that are not individually identified as such because their individual identification as “first” and “second” is arbitrary. The pivot arm assemblies 105 are carried by, and extend forwardly of, a handle assembly 170 that extends longitudinally along a handle axis A_{H} about which handle axis A_{H} the pivot arm assemblies 105 are disposed symmetrically. The pivot arm assemblies 105 cooperatively function as a spring when pressure is applied to the handle assembly 170 during painting. That is, as force is applied to the handle assembly 170 during painting, the pivot arm assemblies 105 flex and deflect in an outwardly direction, thereby providing a shock-absorbing feature, as further described below.

Each pivot arm assembly 105 includes a pivot arm 110, a pivot axle base 115, and a pivot arm gear 120. Because the pivot arm gear 120 of each pivot arm assembly 105 is more proximate the handle assembly 170 than is the pivot axle base 115, the opposed ends of each pivot arm 110 coupled to the pivot arm gear 120 and the pivot axle base 115 may alternatively be referred to as, respectively, the proximate and distal ends of that pivot arm 110.

With initial reference to either or both of FIGS. 1 and 2, a hub assembly 127 is pivotably coupled to each pivot axle base 115 for angular movement (i.e., rotation or pivoting) about a hub-pivot axis A_{HP}. In the illustrative embodiment of FIG. 1, the hub-pivot axes A_{HP} are shown as extending through and perpendicularly to the plane of the drawing sheet, as well as orthogonally to the handle axis A_{H}. Each hub assembly 127 includes a pivot axle 125, a hub 130 and a hub cap 135. The pivot axle 125 by which the hub assembly 127 is pivotably mounted to the pivot axle base 115 of the pivot arm assembly 105 has extending therefrom a hub axle 126 on which the hub 130 is mounted for rotation about a hub-rotation axis A_{HR}. More specifically, as shown in FIG. 1, an illustrative hub 130 has a cylindrical central channel 132 extending therethrough that is configured to receive, and be retained for rotation by, the hub axle 126.

As shown, for example, in FIGS. 2, 4 and 5, the opposed hubs 130 carried by the pivot arms 110 cooperate to engage and retain a cylindrical paint applicator which, for purposes of the present description and claims, is in the form of a roller cover 305. A typical roller cover 305 includes a cylindrical tubular roller-cover core 306 with inside and outside surfaces 306ᵢ and 306ₒ and a nap 308 (or pile) of absorbent material carried by the outside surface 306o and configured to alternatively absorb paint from a paint source (not shown) and deposit that paint on a surface (not shown). Each hub 130 includes a cylindrical outer surface 134 configured to frictionally engage the inside surface 306i of the roller-cover core 306, and retain the roller cover 305 between the pivot arms 110.

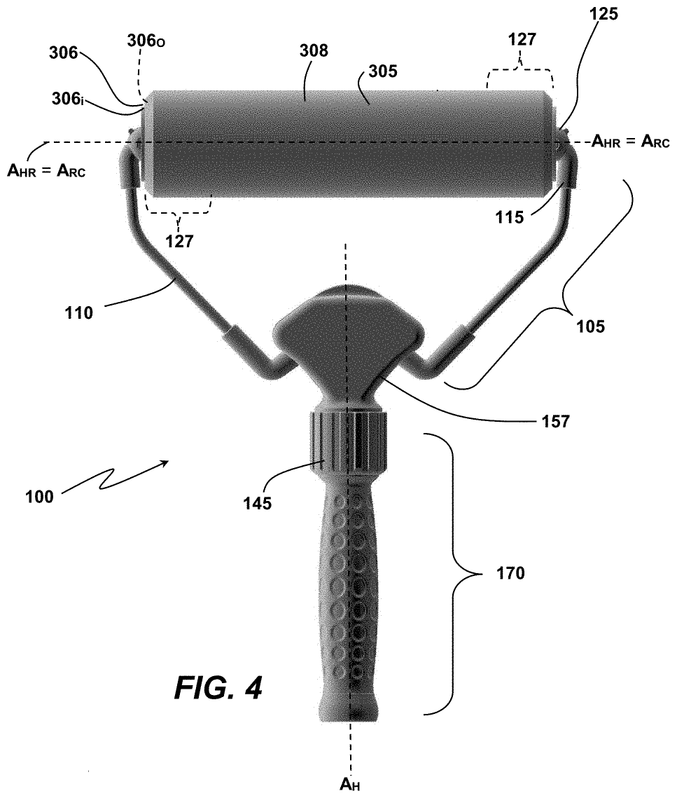

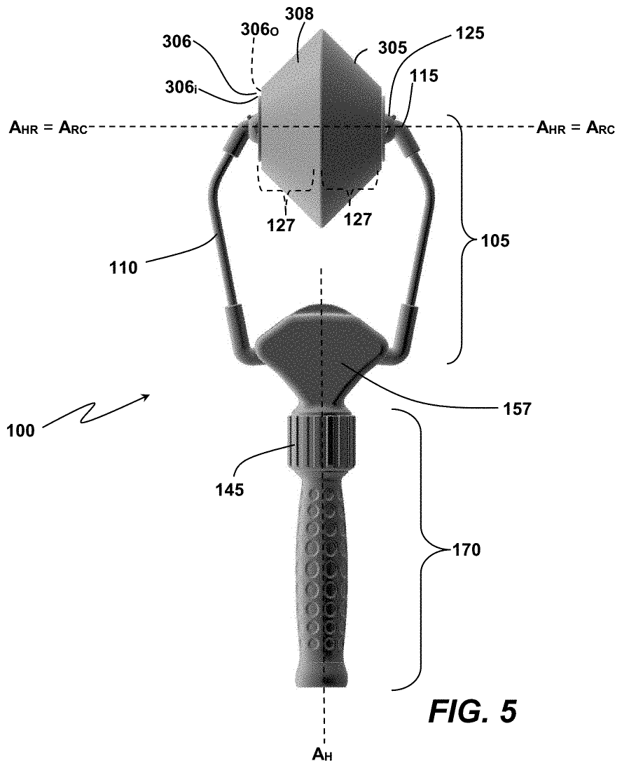

The pivotability of the pivot arms 110 and the hub assemblies 127 with respect to the pivot arms 110 permit the hub-rotation axes A_{HR} defined by the hub axles 126 to align along a common (i.e., “single” or “shared”) roller-cover rotation axis A_{RC} for roller covers 305 of various widths. In fact, the disparate roller lengths that can be accommodated by any given embodiment is theoretically infinite between some minimum and maximum widths corresponding to, respectively, contact between the hubs 130 and the maximum spread of the pivot arms 110. Moreover, as illustrated by comparison of FIGS. 4 and 5, roller covers 305 having disparately configured naps 308 can also be accommodated; FIG. 4 depicts a conventional cylindrical roller cover 305, while the roller cover 305 of FIG. 5 is configured for painting a corner defined by the intersection of two planar surfaces such as two walls or a wall and a ceiling (not shown).

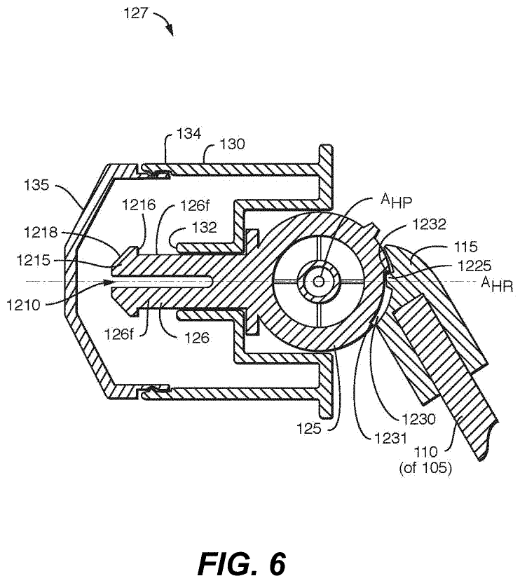

Although in the version of FIG. 1 the central channel 132 and hub axle 126 are of relative sizes (i.e., axial lengths) that permit little, in any, lineal (axial) displacement of the hub 130 along the hub-rotation axis A_{HR} defined by the hub axle 126, embodiments are envisioned in which the hub axle 126 is longer than the central channel 132 of the hub 130 such that the hub 130 is capable of lineal displacement along the hub axle 126. One such embodiment is shown in FIG. 6, which will be described in some detail later in this description. Presently, it is sufficient to note that lineal displacement of the hub 130 along the hub axle 126 allows the pivot arms 110 of alternative versions to flex outwardly while retaining a roller cover 305 without forcing the hubs 130 out of the roller-cover core 306. Allowing the pivot arms 110 to flex provides the aforementioned shock absorption and helps to balance forces applied to the roller cover 305 for more even application of paint.

As described with initial and principal reference to FIG. 1, the paint applicator 100 includes an applicator housing 157 that is attached to the handle assembly 170 and to which each pivot arm 110 is mounted for rotation about an arm-pivot axis AAP. As seen in the version of FIG. 1, the arm-pivot axes AAP extend orthogonally to the handle axis A_{H} and, at least in the case shown, parallel with the hub-pivot axes A_{HP} in order to achieve the movements hereinabove and hereinbelow described. The housing 157 encloses a gear assembly 175. Pivot-gear teeth 122 on the pivot arm gear 120 of each pivot arm assembly 105 intermesh with the teeth 143 of a worm gear 142 carried by worm-drive shaft 140. Thusly assembled, rotation of the worm-drive shaft 140 in a first direction causes the pivot arm assemblies 105 to simultaneously clamp together in an inwardly direction to secure a roller cover 305 between the hubs 130. Conversely, rotation of the worm-drive shaft 140 in a second direction opposite the first direction causes the pivot arms 110 to mutually spread outwardly in symmetric fashion and either (i) release a roller cover 305 retained thereby or (ii) allow for installation of a new roller cover 305. In other words, the pivot arm assemblies 105 are configured to simultaneously rotate in opposite directions relative to the housing 157. Thus, the roller cover 305 can be secured to and released from the universal paint applicator 100 in a “hands free” manner, thereby facilitating simple, quick and less messy changing of roller covers 305.

As in the embodiment of FIGS. 1 and 2, the worm-drive shaft 140 is typically enclosed within the applicator housing 157. In order to facilitate a user's rotation of the worm-drive shaft 140 from the exterior of the housing, the applicator 100 of FIG. 1 illustratively includes a ring gear 145 disposed coaxially with the worm-drive shaft 140 and having an annular exterior surface 146 that is at least partially accessible from the exterior of the applicator housing 157 and the handle assembly 170. In the version of FIGS. 1, 2 and 3, the ring gear 145 is essentially a collar with the exterior surface 146 annularly disposed about a portion of the handle assembly 170. An interior surface 147 of the ring gear 145 carries internal ring-gear teeth 148, the purpose of which will be subsequently described.

With continued reference to FIG. 1, but especially the exploded view of FIG. 2, when assembled, a planet gear 150 is disposed between the interior surface 147 of the ring gear 145 and the portion of the cylindrical outer surface of the worm-drive shaft 140. The planet gear 150 has external planet-gear teeth 152 that intermesh with the internal ring-gear teeth 148. Moreover, the worm-drive shaft 140 carries external drive-shaft teeth 144 that intermesh with the external planet-gear teeth 152. It will be readily appreciated by a person of ordinary skill in the relevant art, and a person with general mechanical knowledge, that, when the aforesaid components are thusly assembled, rotation of the ring gear 145 causes rotation of the planet gear 150 and, in turn, rotation of the worm-drive shaft 140 by the rotating planet gear 150, thereby causing the pivot arm assemblies 105 to pivot toward or away from one another to retain or release a roller cover 305. In this arrangement, the portion of the worm-drive shaft 140 about which the drive-shaft teeth 144 are annularly disposed functions essentially as a “sun gear” in what may be regarded as a sun-gear, planet-gear, ring-gear system functioning as a part of the pivot arm actuator. Details of the bi-directional pivot arm actuator, including, collectively, the worm-drive shaft 140, the planet gear(s) 150, and the ring gear 145, are revisited later in the present description, and discussed in conjunction with additional drawings because understanding those facilitates an understanding of the present improvements upon the invention of the '548 patent.

Although the construction of the handle assembly 170 is of no particular consequence, FIG. 2 depicts an embodiment in which the handle assembly 170 includes first and second handle members 155 and 160 which are selectively held together in part by a retaining ring 165. Exterior surfaces of the handle members 155 and 160 may include undulations such as, by way of non-limiting example, indentations 410 (of FIG. 3) in order to facilitate gripping. The indentations 410 may be circular, elliptical, oval or of any other advantageous configuration. Internal threads 180 disposed within a bottom portion of the handle assembly 170 can receive an extension pole or rod (not shown) so that the universal paint applicator 100 can be extended to reach high regions of a wall or a ceiling, for example.

Referring to FIG. 6, the details of an illustrative hub assembly 127 are now revisited. As previously described, a hub assembly 127 includes a pivot axle 125, a hub 130 and a hub cap 135. The hub cap 135 is tapered in order to facilitate insertion into a roller-cover core 306, as described in the summary.

In order to facilitate retention and removal of the hub 130 from the hub axle 126, the hub axle 126 is split to define at least one slot 1210 extending along the hub-rotation axis A_{HR}. More specifically, by virtue of the slot 1210, the hub axle 126 includes at least two axle fingers 126f extending in parallel along the hub-rotation axis A_{HR}. Each finger 126f terminates in a hub retainer 1215 that has a flanged catch 1216 and a sloped surface 1218 that angles toward the hub-rotation axis A_{HR} in a direction moving away from the pivot axle 125 from which the hub axle 126 depends. The fingers 126f can be temporarily flexed toward one another to allow a hub 130 to be mounted over, and retained by, the hub axle 126. More specifically, the hub retainers 1215 are configured to extend wider than the diameter of the central channel 132 in the hub 130 such that, as the sloped surfaces 1218 of the hub retainers 1215 are urged into the central channel 132, the fingers 126f flex inwardly and that the fingers 126f and hub retainers 1215 can pass through the central channel 132. Once the hub retainers 1215 emerge from the other side of the central channel 132, the fingers 126f spread back out to their non-flexed attitudes, and the hub 130 is axially retained by the flanged catches 1216. To remove the hub 130, the fingers 126f are flexed inwardly so that the hub retainers 1215 can pass back out through the central channel 132.

As indicated in the summary relative to some embodiments, the extent of angular movement between the hub assembly 127 and the pivot arm 110 to which the hub assembly 127 is coupled is intentionally limited. More specifically, it is advantageous for the hubs 130 to be facing generally inwardly toward the handle axis A_{H}, but to have some degree of angular movement in order to facilitate “capture” of a roller cover 305, as well as the retention of roller covers 305 of various lengths. To this end, illustratively configured components are shown in FIG. 6 in which the pivot axle 125 has defined therein an arcuate slot 1230 (or “race”) centered on the hub-pivot axis A_{HP} and defined by first and second slot ends 1231 and 1232. Protruding from the pivot axle base 115, and into the slot 1230, is a pivot stop 1225 that defines the extremes of angular motion for the hub assembly 127 in each direction by abutting engagement with, alternatively, the first and second slot ends 1231 and 1232. The degree of angular freedom—or range of pivot or rotation—in such an embodiment will obviously depend on the arc length of the arcuate slot 1230. While a single example of how angular motion of the hub assembly 127 is limited is provided for illustrative purposes, it is to be understood that the example provided is by no means limiting of the manner in which said angular motion can be limited, and that the more important overall concept is that the pivot range of the hub assembly 127 can be limited to within a predetermined angular range by any suitable means.

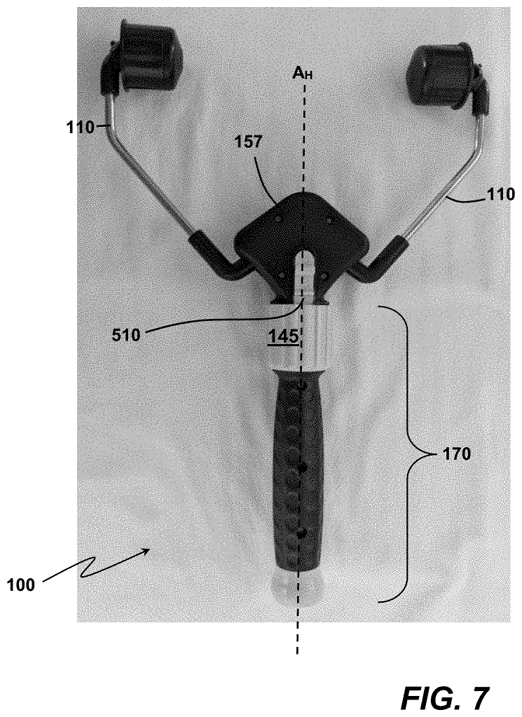

As alluded to in the background and the summary, as well as earlier in the detailed description, universal paint applicators 100 of the type expressly disclosed in and covered within the scope of the '548 patent, have met with certain limitations under certain operating conditions. More specifically, as explained above, and in the '548 patent, each hub 130 includes a cylindrical outer surface 134 configured to frictionally engage the inside surface 306i of the roller-cover core 306, and retain the roller cover 305 between the pivot arms 110. When subjected to continuous long-term use on a given project, the frictional engagement between the hubs 130 and the roller-cover core 306 is sometimes overcome by other forces exerted during painting, causing the pivot arms 110 to spread away from one another and the hubs 130 to work their way of the roller-cover cores 306. The mechanisms described below with conjunctive reference to FIG. 7-10 address these functional limitations associated with the previous generation of the “universal paint applicator” by selectively preventing undesired spread of the pivot arms 110.

### Pivot-Arm Locking Mechanisms

With reference to FIGS. 7-10, illustrative pivot-arm locking mechanisms are described. Components new to the present case are referred to using numeric, alphabetic and/or alphanumeric reference characters not previously used in the '548 patent. However, components of the present illustrative paint applicator 100 correlating to components previously disclosed in the '548 patent are referenced by the same reference characters used in the '548 patent. By virtue of the necessity of providing context, the description of some components may be redundant with descriptions provided in the '548 patent and/or descriptions provided above.

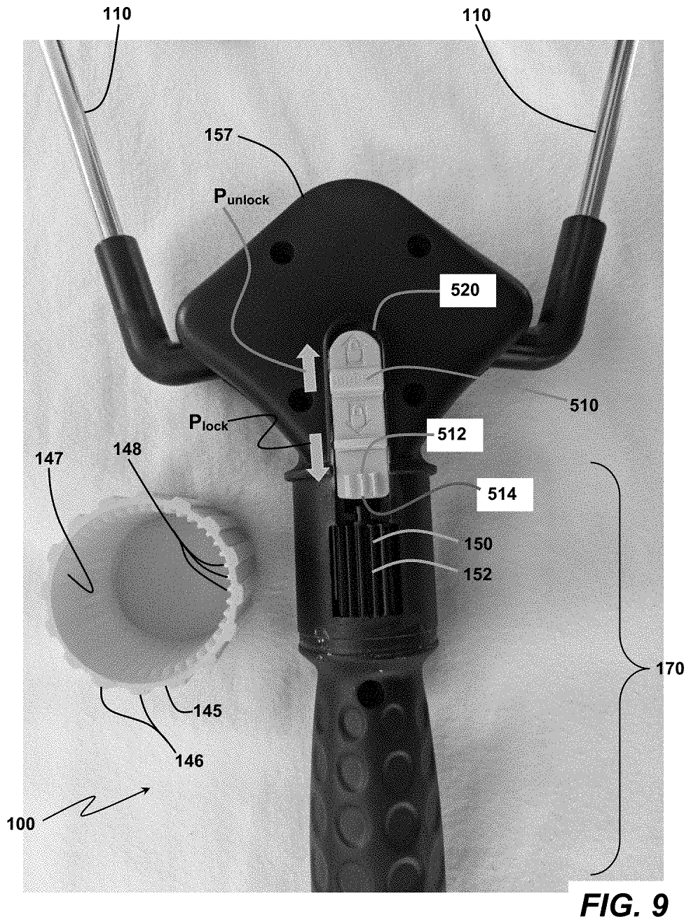

As previously described, pivoting of the pivot arms 110 to engage or release a roller cover 305 is facilitated by a worm-drive shaft 140 carried by the applicator housing 157. In order to facilitate a user's rotation of the worm-drive shaft 140 from the exterior of the housing, the applicator 100 of FIG. 1 illustratively includes a ring gear 145 disposed annularly about the worm-drive shaft 140 and having an annular exterior surface 146 accessible to a user (a user's hand) from the exterior of the applicator housing 157 and the handle assembly 170. In the version of FIGS. 1, 2 and 3, the ring gear 145 is essentially a collar with the exterior surface 146 annularly disposed about a portion of the handle assembly 170. As best seen in FIG. 9, an interior surface 147 of the ring gear 145 carries internal ring-gear teeth 148, the purpose of which will be subsequently described.

Although the mechanisms by which the pivot arms 110 are pivoted (e.g., collectively, the pivot arm actuator) were previously described with reference to FIG. 1, the following aspects are most clearly appreciated with reference to FIGS. 7-10, FIGS. 9 and 10 of which show the handle assembly 170 and applicator housing 157 in disparate states of disassembly in order to reveal internal gear assembly 175 along with components of the pivot-arm locking mechanisms.

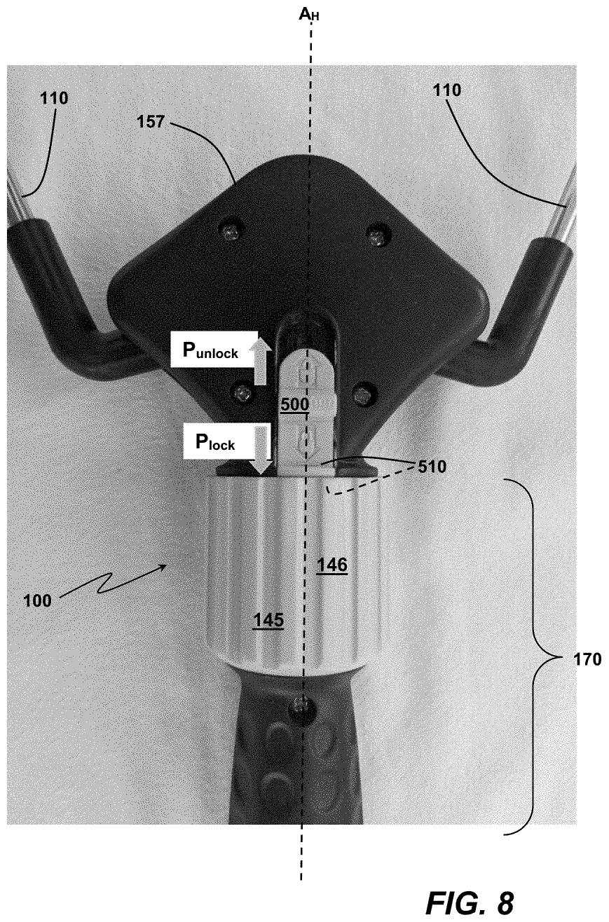

Referring to FIGS. 7 and 8, an actuator lock 500 includes a lock slide 510 carried by the handle assembly 170 for lineal displacement along the handle axis A_{H} between first and second lineal positions corresponding to, respectively, locked and unlocked positions P_{lock} and P_{unlock}, each of which is depicted in both FIGS. 7 and 8. The locked position is such that the lock slide 510 mechanically interferes with movement of the pivot arm actuator and pivot arms 110. More specially, as shown in FIG. 8, the locked position P_{Lock} is such that the lock slide 510 prevents movement (i.e., rotation) of the ring gear 145 and, by extension, pivoting of the pivot arms 110. Conversely, with reference to FIGS. 7 and 8, the unlocked position P_{unlock} is such that the lock slide 510 is lineally displaced away from (i.e., out of mechanical engagement with) the ring gear 145 such that the lock slide 510 does not mechanically interfere with the ring gear 145 so that the ring gear 145 is free to rotate and the pivot arms 110 are free to pivot.

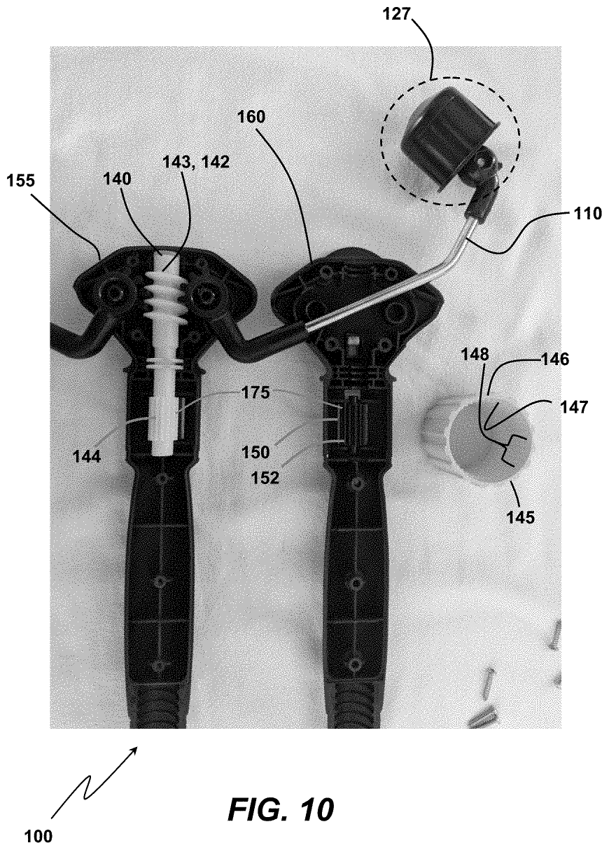

A more in-depth understanding of the pivot-arm locking mechanisms is facilitated with reference to FIGS. 9 and 10 showing the handle assembly 170 and applicator housing 157 in different states of disassembly. In FIG. 9, the ring gear 145 is removed from the handle assembly 170 and situated adjacent thereto, exposing both the interior surface 147 of the ring gear 145 and, in this case, a first of two planet gears 150 that is retained by the first handle member 155, and normally shrouded from view by the ring gear 145. In FIG. 10, the first and second handle members 155 and 160 have been separated and set beside one another, and beside the ring gear 145, thereby exposing the worm-draft shaft 140 and the second of the two planet gears 150 that is retained by the second handle member 160 and, like the first planet gear 150, normally shrouded from view by the ring gear 145.

Referring again to FIG. 9, it can be seen that the lock slide 510 is retained for the aforesaid lineal displacement within a lock-slide track 520. Although the lock-slide track 520 is depicted as defined with the first handle member 155, the designation of first handle member 155 is arbitrary. More broadly, the lock-slide track 520 is defined along the handle assembly 170. The lock slide 510 carries a gear-engagement portion 512 that is either attached to the lock slide 510 or integrally formed therewith. The gear-engagement portion 512 may comprise a single protrusion 514 configured to for selective insertion between two adjacent internal ring-gear teeth 148 defined along the interior surface 147 of the ring gear 145. In the particular configuration depicted, there are three protrusions 514, each of which can be selectively inserted between two adjacent ring-gear teeth 148. Moreover, each of the at least one protrusions 514 can be configured in the shape of a “tooth” complementary in configuration to the ring-gear teeth 148 in order to facilitated an “intermeshed” mechanical interference between the at least one protrusion 514 and two adjacent ring-gear teeth 148.

It will be readily appreciated that the insertion between adjacent ring-gear teeth 148 is achieved by displacing the lock slide 510 toward a locked position. More specifically, the introduction of the at least one protrusion 514 between adjacent ring-gear teeth 514 in a manner that prevents rotation of the ring gear 145 about the handle assembly 170 defines a “locked position.” Conversely, sliding of the lock slide 510 toward and unlocked position with the lock-slide track 520 removes the mechanical interference between the at least one protrusion 514 and the ring-gear teeth 148, the very condition that defines an “unlocked position.” It will also be appreciated that there is overlap among components of the pivot arm actuator and pivot-arm locking mechanisms, most centrally, the ring gear 145.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A universal paint applicator configured for use in combination with a roller cover including a cylindrical roller-cover core with an inside surface and an outside surface carrying an absorbent material for alternatively absorbing and depositing paint on a surface, the applicator comprising:
a handle assembly that extends longitudinally along a handle axis;
first and second pivot arm assemblies carried by, and extending forwardly of, the handle assembly such that the pivot arms are disposed symmetrically about the handle axis, each pivot arm assembly including a pivot arm having a proximate end by which it depends from the handle assembly for rotation about a pivot arm axis and a distal end opposite the proximate end and disposed forwardly of the handle assembly;
a bi-directional pivot arm actuator carried by the handle and cooperatively linked to each pivot arm assembly such that movement of the actuator in a first direction causes the pivot arms to rotate toward one another and movement of the actuator in a second direction, opposite the first direction, causes the pivot arm assemblies to rotate away from one another;
an actuator lock carried by the handle assembly and including a lock slide linearly displaceable along the handle axis between a locked position and unlocked position, the locked position being such that the lock slide mechanically interferes with the pivot arm actuator in order to prevent movement of the actuator and pivot arms, and the unlocked position being such that the lock slide does not mechanically interfere with movement of the pivot arm actuator and pivot arms; and
a hub assembly pivotably coupled to the distal end of each of the first and second pivot arms for angular movement about a hub-pivot axis, each hub assembly including a hub axle and a hub mounted for rotation on the hub axle about a hub-rotation axis defined by the hub axle, each hub including an outer surface configured to frictionally engage the inside surface of the roller-cover core such that the hubs of the first and second pivot arms cooperate to retain the roller cover between the pivot arms; wherein
the hub-rotation axes, hub-pivot axes and pivot arm axes are movable into disparate mutual orientations such that, when the pivot arms are spread to various degrees, the hub-rotation axes can be aligned to define a common roller-cover rotation axis so that the roller cover cooperatively retained by the hubs can be of any length between a predetermined minimum length and a pre-determined maximum length.

2. The paint applicator of claim 1 wherein
(i) each pivot arm assembly further includes at the proximate end of each pivot arm a pivot arm gear having pivot-gear teeth; and
(ii) the pivot arm actuator comprises a worm-drive shaft carrying a worm gear with teeth that intermesh with the pivot-gear teeth of each pivot arm such that rotation of the worm-drive shaft in a first direction causes the pivot arms to rotate about their pivot arm axes inwardly toward one another and rotation of the worm-drive shaft in a second direction opposite the first direction causes the pivot arms to mutually spread in an outwardly direction thereby facilitating, respectively, engagement and disengagement of the outer surfaces of the hubs with the inside surface of the roller-cover core.

3. The paint applicator of claim 2 wherein the worm-drive shaft further carries external drive-shaft teeth and the pivot arm actuator further comprises:
(i) a ring gear disposed coaxially with the worm-drive shaft and having an interior surface that carries internal ring-gear teeth and an exterior surface annularly disposed about a portion of the handle assembly and accessible to a user; and
(ii) at least one planet gear disposed between the interior surface of the ring gear and the worm-drive shaft, the at least one planet gear having external planet-gear teeth that intermesh with the internal ring-gear teeth and the external drive-shaft teeth such that rotation of the ring gear by a user causes rotation of the planet gear and, in turn, rotation of the worm-drive shaft, thereby causing the pivot arm assemblies to pivot one of (a) toward and (b) away from one another.

4. The paint applicator of claim 3 wherein the locked and unlocked positions of the lock slide are such that, respectively, (i) the lock slide mechanically interferes with the ring gear to prevent rotation of the ring gear and (ii) the lock slide does not mechanically interfere with the ring gear so that the ring gear is free to rotate.

5. The paint applicator of claim 4 wherein the lock slide carries a gear-engagement portion that is caused to be inserted between two adjacent ring-gear teeth when the lock slide is in the locked position.

6. A paint applicator configured for use in combination with a roller cover including a cylindrical roller-cover core with an inside surface and an outside surface carrying an absorbent material for alternatively absorbing and depositing paint on a surface, the applicator comprising:
a handle assembly that extends longitudinally along a handle axis;
first and second pivot arm assemblies carried by the handle assembly, each pivot arm assembly including a pivot arm having a proximate end by which it depends from the handle assembly for rotation about a pivot arm axis and a distal end opposite the proximate end;
a bi-directional pivot arm actuator carried by the handle and cooperatively linked to each pivot arm assembly such that movement of the actuator in opposed first and second directions causes the pivot arms to rotate, respectively toward and away from one another;
an actuator lock carried by the handle assembly and including a lock slide displaceable between opposed locked and unlocked positions in which the lock slide, respectively, (i) mechanically interferes with the pivot arm actuator in order to prevent movement of the actuator and pivot arms and (ii) does not mechanically interfere with movement of the pivot arm actuator and pivot arms; and
a hub assembly pivotably coupled to the distal end of each of the first and second pivot arms for angular movement about a hub-pivot axis, each hub assembly including a hub axle and a hub mounted for rotation on the hub axle about a hub-rotation axis defined by the hub axle, each hub including an outer surface configured to frictionally engage the inside surface of the roller-cover core such that the hubs of the first and second pivot arms cooperate to retain the roller cover between the pivot arms.
